(19) United States
(12) Patent Application Publication
(10) Pub. No.: US 2012/0246381 A1
(43) Pub. Date: Sep. 27, 2012

(54) Input Output Memory Management Unit (IOMMU) Two-Layer Addressing

(76) Inventors: Andy Kegel, Redmond, WA (US); Mark Hummel, Franklin, MA (US); Steve Glaser, San Francisco, CA (US); Tony Asaro, Toronto (CA); Philip NG, Toronto (CA); Jeffrey Cheng, Toronto (CA)

(21) Appl. No.: 13/309,750

(22) Filed: Dec. 2, 2011

Related U.S. Application Data
(60) Provisional application No. 61/423,062, filed on Dec. 14, 2010.

(51) Int. Cl. G06F 12/10

(52) U.S. Cl. 711/6; 711/206; 711/E12.058

(57) ABSTRACT

Embodiments of the present invention provide methods, systems, and computer readable media for input output memory management unit (IOMMU) two-layer addressing in the context of memory address translations for I/O devices. According to an embodiment, a method includes translating a guest virtual address (GVA) to a corresponding guest physical address (GPA) using a guest address translation table according to a process address space identifier associated with an address translation transaction associated with an I/O device, and translating the GPA to a corresponding system physical address (SPA) using a system address translation table according to a device identifier associated with the address translation transaction.

### CROSS REFERENCE TO RELATED APPLICATIONS

This application claims priority under 35 U.S.C. §119(e) to U.S. Provisional Application No. 61/423,062, filed Dec. 14, 2010, which is incorporated by reference herein in its entirety.

### BACKGROUND OF THE INVENTION

1. Field of the Invention

The present invention is generally directed to computer systems. More particularly, the present invention is directed to input/output memory management units.

2. Background Art

The desire to use a graphics processing unit (GPU) for general computation has become much more pronounced recently due to the GPU's exemplary performance per unit power and/or cost. The computational capabilities for GPUs, generally, have grown at a rate exceeding that of the corresponding central processing unit (CPU) platforms. This growth, coupled with the explosion of the mobile computing market (e.g., notebooks, mobile smart phones, tablets, etc.) and its necessary supporting server/enterprise systems, has been used to provide a specified quality of desired user experience. Consequently, the combined use of CPUs and GPUs for executing workloads with data parallel content is becoming a volume technology.

However, GPUs have traditionally operated in a constrained programming environment, available primarily for the acceleration of graphics. These constraints arose from the fact that GPUs did not have as rich a programming ecosystem as CPUs. Their use, therefore, has been mostly limited to two dimensional (2D) and three dimensional (3D) graphics and a few leading edge multimedia applications, which are already accustomed to dealing with graphics and video application programming interfaces (APIs).

With the advent of multi-vendor supported OpenCL® and DirectCompute®, standard APs and supporting tools, the limitations of the GPUs in traditional applications has been extended beyond traditional graphics. Although OpenCL and DirectCompute are a promising start, there are many hurdles remaining to creating an environment and ecosystem that allows the combination of a CPU and a GPU to be used as fluidly as the CPU for most programming tasks.

Existing computing systems often include multiple processing devices. For example, some computing systems include both a CPU and a GPU on separate chips (e.g., the CPU might be located on a motherboard and the GPU might be located on a graphics card) or in a single chip package. Both of these arrangements, however, still include significant challenges associated with (i) efficient scheduling, (ii) providing quality of service (QoS) guarantees between processes, (iii) programming model, (iv) compiling to multiple target instruction set architectures (ISAs), and (v) separate memory systems, —all while minimizing power consumption.

For example, the discrete chip arrangement forces system and software architects to utilize chip to chip interfaces for each processor to access memory. While these external interfaces (e.g., chip to chip) negatively affect memory latency and power consumption for cooperating heterogeneous processors, the separate memory systems (i.e., separate address spaces) and driver managed shared memory create overhead that becomes unacceptable for fine grain offload.

The GPU, along with other peripherals (e.g., input/output (I/O) devices) may need to access information stored in system memory of a computing system. For enhanced performance, the computing system may provide virtual memory capabilities for the I/O device. Accordingly, the I/O device may request information based on a virtual address, and the computing system translates the virtual address to a physical address corresponding to system memory. An input/output memory management unit (IOMMU) may provide address translation services between the I/O device and system memory.

The computing system can also provide multiple virtualized systems, including virtualized guest operating systems (OSes) managed by a hypervisor. In order to provide access to an I/O device, the computing system can virtualize an I/O device for each guest OS. That is, the hypervisor manipulates system memory by coordinating conversions from virtual memory addresses to physical memory addresses for each of the virtualized guest OSes. This process is performed so that each virtualized system can access the I/O device as though each guest OS was the only OS accessing the I/O device.

Thus, the hypervisor can become a bottleneck as it executes software routines to accommodate all of the requests for address translations. Since each of these translations is associated with accessing the IOMMU, the software based operation of the hypervisor represents significant overhead. This overhead can degrade performance.

### SUMMARY OF EMBODIMENTS OF THE INVENTION

What is needed, therefore, is the ability to provide address translation for guest OSes in a computing system.

Although GPUs, accelerated processing units (APUs), and general purpose use of the graphics processing unit (GPGPU) are commonly used terms in this field, the expression “accelerated processing device (APD)” is considered to be a broader expression. For example, APD refers to any cooperating collection of hardware and/or software that performs those functions and computations associated with accelerating graphics processing tasks, data parallel tasks, or nested data parallel tasks in an accelerated manner compared to conventional CPUs, conventional GPUs, software and/or combinations thereof.

Embodiments of the present invention, in certain circumstances, relate to methods, systems, and computer readable media for IOMMU two-layer addressing in the context of memory address translations for I/O devices. An exemplary method includes translating a guest virtual address (GVA) to a corresponding guest physical address (GPA) using a guest address translation table according to a process address space identifier associated with an address translation transaction associated with an I/O device. The GPA is translated to a corresponding system physical address (SPA) using a system address translation table according to a device identifier associated with the address translation transaction.

Additional features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. Various embodiments of the present invention are described below with reference to the drawings, wherein like reference numerals are used to refer to like elements throughout.

FIG. 1A is an illustrative block diagram of a processing system in accordance with embodiments of the present invention.

FIG. 1B is an illustrative block diagram illustration of the accelerated processing device illustrated in FIG. 1A.

FIG. 2 is an illustrative block diagram of IOMMU architecture and memory management for the CPU and I/O devices, and system memory mapping structure in accordance with embodiments of the present invention.

FIG. 3 is an illustrative block diagram of a virtualized system in accordance with embodiments of the present invention.

FIG. 4 is an illustrative block diagram of data structures associated with an IOMMU and system memory in accordance with embodiments of the present invention.

FIG. 5 is an illustrative block diagram of data structures associated with two-layer address translation.

FIG. 6A is an illustrative block diagram of a two-layer address translation system in accordance with embodiments of the present invention.

FIG. 6B is an illustrative block diagram of a GVA-to-SPA address translation system in accordance with embodiments of the present invention.

FIG. 7 is an illustrative block diagram of a flowchart illustrating two-layer addressing in accordance with embodiments of the present invention.

### DETAILED DESCRIPTION OF EMBODIMENTS OF THE INVENTION

In the detailed description that follows, references to “one embodiment,” “an embodiment,” “an example embodiment,” etc., indicate that the embodiment described may include a particular feature, stricture, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

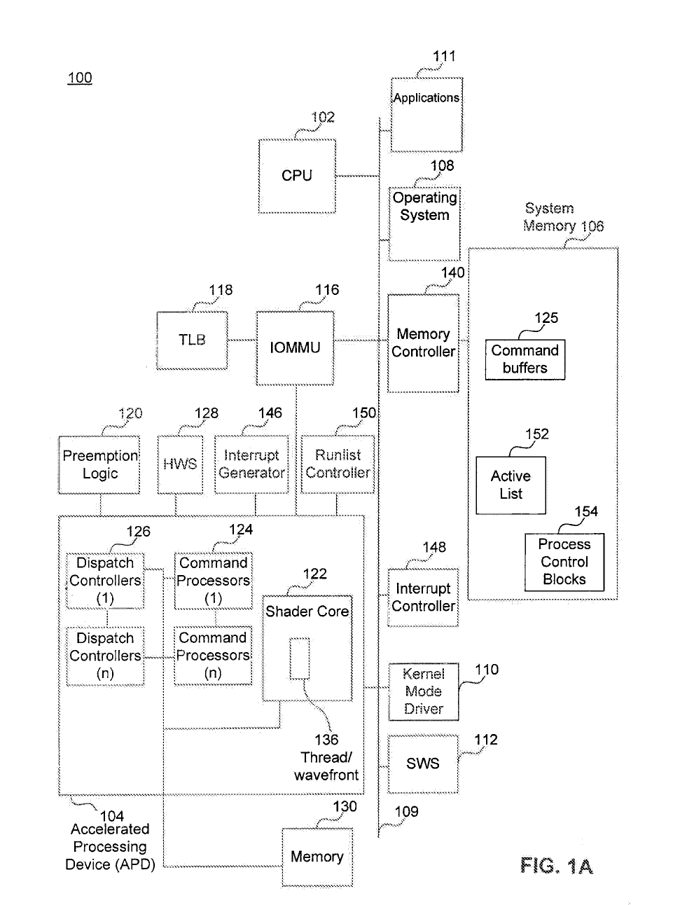

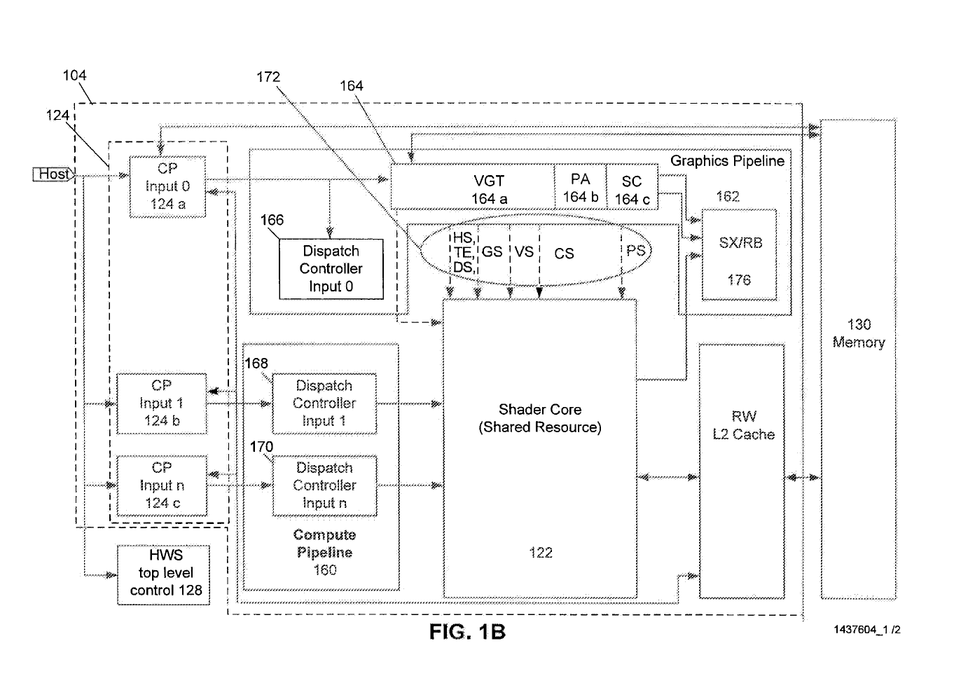

FIG. 1A is an exemplary illustration of a unified computing system 100 including two processors, a CPU 102 and an APD 104. CPU 102 can include one or more single or multi core CPUs. In one embodiment of the present invention, the system 100 is formed on a single silicon die or package, combining CPU 102 and APD 104 to provide a unified programming and execution environment. This environment enables the APD 104 to be used as fluidly as the CPU 102 for some programming tasks. However, it is not an absolute requirement of this invention that the CPU 102 and APD 104 be formed on a single silicon die. In some embodiments, it is possible for them to be formed separately and mounted on the same or different substrates.

In one example, system 100 also includes a memory 106, an OS 108, and a communication infrastructure 109. The operating system 108 and the communication infrastructure 109 are discussed in greater detail below.

The system 100 also includes a kernel mode driver (KMD) 110, a software scheduler (SWS) 112, and a memory management unit 116, such as input/output memory management unit (IOMMU). Components of system 100 can be implemented as hardware, firmware, software, or any combination thereof. A person of ordinary skill in the art will appreciate that system 100 may include one or more software, hardware, and firmware components in addition to, or different from, that shown in the embodiment shown in FIG. 1A.

In one example, a driver, such as KMD 110, typically communicates with a device through a computer bus or communications subsystem to which the hardware connects. When a calling program invokes a routine in the driver, the driver issues commands to the device. Once the device sends data back to the driver, the driver may invoke routines in the original calling program. In one example, drivers are hardware dependent and operating-system-specific. They usually provide the interrupt handling required for any necessary asynchronous time-dependent hardware interface.

Device drivers, particularly on modern Microsoft Windows® platforms, can run in kernel-mode (Ring 0) or in user-mode (Ring 3). The primary benefit of running a driver in user mode is improved stability, since a poorly written user mode device driver cannot crash the system by overwriting kernel memory. On the other hand, user/kernel-mode transitions usually impose a considerable performance overhead, thereby prohibiting user mode-drivers for low latency and high throughput requirements. Kernel space can be accessed by user module only through the use of system calls. End user programs like the UNIX shell or other GUI based applications are part of the user space. These applications interact with hardware through kernel supported functions.

CPU 102 can include (not shown) one or more of a control processor, field programmable gate array (FPGA), application specific integrated circuit (ASIC), or digital signal processor (DSP). CPU 102, for example, executes the control logic, including the OS 108, KMD 110, SWS 112, and applications 111, that control the operation of computing system 100. In this illustrative embodiment, CPU 102, according to one embodiment, initiates and controls the execution of applications 111 by, for example, distributing the processing associated with that application across the CPU 102 and other processing resources, such as the APD 104.

APD 104, among other things, executes commands and programs for selected functions, such as graphics operations and other operations that may be, for example, particularly suited for parallel processing. In general, APD 104 can be frequently used for executing graphics pipeline operations, such as pixel operations, geometric computations, and rendering an image to a display. In various embodiments of the present invention, APD 104 can also execute compute processing operations (e.g., those operations unrelated to graphics such as, for example, video operations, physics simulations, computational fluid dynamics, etc.), based on commands or instructions received from CPU 102.

For example, commands can be considered as special instructions that are not typically defined in the instruction set architecture (ISA). A command may be executed by a special processor such a dispatch processor, command processor, or network controller. On the other hand, instructions can be considered, for example, a single operation of a processor within a computer architecture. In one example, when using two sets of ISAs, some instructions are used to execute x86 programs and some instructions are used to execute kernels on an APD compute unit.

In an illustrative embodiment, CPU 102 transmits selected commands to APD 104. These selected commands can include graphics commands and other commands amenable to parallel execution. These selected commands, that can also include compute processing commands, can be executed substantially independently from CPU 102.

APD 104 can include its own compute units (not shown), such as, but not limited to, one or more SIMD processing cores. As referred to herein, a SIMD is a pipeline, or programming model, where a kernel is executed concurrently on multiple processing elements each with its own data and a shared program counter. All processing elements execute an identical set of instructions. The use of predication enables work-items to participate or not for each issued command.

In one example, each APD 104 compute unit can include one or more scalar and/or vector floating-point units and/or arithmetic and logic units (ALUs). The APD compute unit can also include special purpose processing units (not shown), such as inverse-square root units and sine/cosine units. In one example, the APD compute units are referred to herein collectively as shader core 122.

Having one or more SIMDs, in general, makes APD 104 ideally suited for execution of data-parallel tasks such as those that are common in graphics processing.

Some graphics pipeline operations, such as pixel processing, and other parallel computation operations, can require that the same command stream or compute kernel be performed on streams or collections of input data elements. Respective instantiations of the same compute kernel can be executed concurrently on multiple compute units in shader core 122 in order to process such data elements in parallel. As referred to herein, for example, a compute kernel is a function containing instructions declared in a program and executed on an APD compute unit. This function is also referred to as a kernel, a shader, a shader program, or a program.

In one illustrative embodiment, each compute unit (e.g., SIMD processing core) can execute a respective instantiation of a particular work-item to process incoming data. A work-item is one of a collection of parallel executions of a kernel invoked on a device by a command. A work-item can be executed by one or more processing elements as part of a work-group executing on a compute unit.

A work-item is distinguished from other executions within the collection by its global ID and local ID. In one example, a subset of work-items in a workgroup that execute simultaneously together on a SIMD can be referred to as a wavefront 136. The width of a wavefront is a characteristic of the hardware of the compute unit (e.g., SIMD processing core). As referred to herein, a workgroup is a collection of related work-items that execute on a single compute unit. The work-items in the group execute the same kernel and share local memory and work-group barriers.

In the exemplary embodiment, all wavefronts from a workgroup are processed on the same SIMD processing core. Instructions across a wavefront are issued one at a time, and when all work-items follow the same control flow, each work-item executes the same program. Wavefronts can also be referred to as warps, vectors, or threads.

An execution mask and work-item predication are used to enable divergent control flow within a wavefront, where each individual work-item can actually take a unique code path through the kernel. Partially populated wavefronts can be processed when a full set of work-items is not available at wavefront start time. For example, shader core 122 can simultaneously execute a predetermined number of wavefronts 136, each wavefront 136 comprising a multiple work-items.

Within the system 100, APD 104 includes its own memory, such as graphics memory 130 (although memory 130 is not limited to graphics only use). Graphics memory 130 provides a local memory for use during computations in APD 104. Individual compute units (not shown) within shader core 122 can have their own local data store (not shown). In one embodiment, APD 104 includes access to local graphics memory 130, as well as access to the memory 106. In another embodiment, APD 104 can include access to dynamic random access memory (DRAM) or other such memories (not shown) attached directly to the APD 104 and separately from memory 106.

In the example shown, APD 104 also includes one or “n” number of command processors (CPs) 124. CP 124 controls the processing within APD 104. CP 124 also retrieves commands to be executed from command buffers 125 in memory 106 and coordinates the execution of those commands on APD 104.

In one example, CPU 102 inputs commands based on applications 111 into appropriate command buffers 125. As referred to herein, an application is the combination of the program parts that will execute on the compute units within the CPU and the APD.

A plurality of command buffers 125 can be maintained with each process scheduled for execution on the APD 104.

CP 124 can be implemented in hardware, firmware, or software, or a combination thereof. In one embodiment, CP 124 is implemented as a reduced instruction set computer (RISC) engine with microcode for implementing logic including scheduling logic.

APD 104 also includes one or “n” number of dispatch controllers (DCs) 126. In the present application, the term dispatch refers to a command executed by a dispatch controller that uses the context state to initiate the start of the execution of a kernel for a set of work groups on a set of compute units. DC 126 includes logic to initiate workgroups in the shader core 122. In some embodiments, DC 126 can be implemented as part of CP 124.

System 100 also includes a hardware scheduler (HWS) 128 for selecting a process from a run list 150 for execution on APD 104. HWS 128 can select processes from run list 150 using round robin methodology, priority level, or based on other scheduling policies. The priority level, for example, can be dynamically determined. HWS 128 can also include functionality to manage the run list 150, for example, by adding new processes and by deleting existing processes from run-list 150. The run list management logic of HWS 128 is sometimes referred to as a run list controller (RLC).

In various embodiments of the present invention, when HWS 128 initiates the execution of a process from RLC 150, CP 124 begins retrieving and executing commands from the corresponding command buffer 125. In some instances, CP 124 can generate one or more commands to be executed within APD 104, which correspond with commands received from CPU 102. In one embodiment, CP 124, together with other components, implements a prioritizing and scheduling of commands on APD 104 in a manner that improves or maximizes the utilization of the resources of APD 104 and/or system 100.

APD 104 can have access to, or may include, an interrupt generator 146. Interrupt generator 146 can be configured by APD 104 to interrupt the OS 108 when interrupt events, such as page faults, are encountered by APD 104. For example, APD 104 can rely on interrupt generation logic within IOMMU 116 to create the page fault interrupts noted above.

APD 104 can also include preemption and context switch logic 120 for preempting a process currently running within shader core 122. Context switch logic 120, for example, includes functionality to stop the process and save its current state (e.g., shader core 122 state, and CP 124 state).

As referred to herein, the term state can include an initial state, an intermediate state, and/or a final state. An initial state is a starting point for a machine to process an input data set according to a programming order to create an output set of data. There is an intermediate state, for example, that needs to be stored at several points to enable the processing to make forward progress. This intermediate state is sometimes stored to allow a continuation of execution at a later time when interrupted by some other process. There is also final state that can be recorded as part of the output data set.

Preemption and context switch logic 120 can also include logic to context switch another process into the APD 104. The functionality to context switch another process into running on the APD 104 may include instantiating the process, for example, through the CP 124 and DC 126 to run on APD 104, restoring any previously saved state for that process, and starting its execution.

Memory 106 can include non-persistent memory such as DRAM (not shown). Memory 106 can store, e.g., processing logic instructions, constant values, and variable values during execution of portions of applications or other processing logic. For example, in one embodiment, parts of control logic to perform one or more operations on CPU 102 can reside within memory 106 during execution of the respective portions of the operation by CPU 102.

During execution, respective applications, OS functions, processing logic commands, and system software can reside in memory 106. Control logic commands fundamental to OS 108 will generally reside in memory 106 during execution. Other software commands, including, for example, kernel mode driver 110 and software scheduler 112 can also reside in memory 106 during execution of system 100.

In this example, memory 106 includes command buffers 125 that are used by CPU 102 to send commands to APD 104. Memory 106 also contains process lists and process information (e.g., active list 152 and process control blocks 154). These lists, as well as the information, are used by scheduling software executing on CPU 102 to communicate scheduling information to APD 104 and/or related scheduling hardware. Access to memory 106 can be managed by a memory controller 140, which is coupled to memory 106. For example, requests from CPU 102, or from other devices, for reading from or for writing to memory 106 are managed by the memory controller 140.

Referring back to other aspects of system 100, IOMMU 116 is a multi-context memory management unit.

As used herein, context can be considered the environment within which the kernels execute and the domain in which synchronization and memory management is defined. The context includes a set of devices, the memory accessible to those devices, the corresponding memory properties and one or more command-queues used to schedule execution of a kernel(s) or operations on memory objects.

Referring back to the example shown in FIG. 1A, IOMMU 116 includes logic to perform virtual to physical address translation for memory page access for devices including APD 104. IOMMU 116 may also include logic to generate interrupts, for example, when a page access by a device such as APD 104 results in a page fault. IOMMU 116 may also include, or have access to, a translation lookaside buffer (TLB) 118. TLB 118, as an example, can be implemented in a content addressable memory (CAM) to accelerate translation of logical (i.e., virtual) memory addresses to physical memory addresses for requests made by APD 104 for data in memory 106.

In the example shown, communication infrastructure 109 interconnects the components of system 100 as needed. Communication infrastructure 109 can include (not shown) one or more of a peripheral component interconnect (PCI) bus, extended PCI (PCI-E) bus, advanced microcontroller bus architecture (AMBA) bus, advanced graphics port (AGP), or other such communication infrastructure. Communications infrastructure 109 can also include an Ethernet, or similar network, or any suitable physical communications infrastructure that satisfies an application's data transfer rate requirements. Communication infrastructure 109 includes the functionality to interconnect components including components of computing system 100.

In this example, OS 108 includes functionality to manage the hardware components of system 100 and to provide common services. In various embodiments, OS 108 can execute on CPU 102 and provide common services. These common services can include, for example, scheduling applications for execution within CPU 102, fault management, interrupt service, as well as processing the input and output of other applications.

In some embodiments, based on interrupts generated by an interrupt controller, such as interrupt controller 148, OS 108 invokes an appropriate interrupt handling routine. For example, upon detecting a page fault interrupt, OS 108 may invoke an interrupt handler to initiate loading of the relevant page into memory 106 and to update corresponding page tables.

OS 108 may also include functionality to protect system 100 by ensuring that access to hardware components is mediated through OS managed kernel functionality. In effect, OS 108 ensures that applications, such as applications 111, run on CPU 102 in user space. OS 108 also ensures that applications 111 invoke kernel functionality provided by the OS to access hardware and/or input/output functionality.

By way of example, applications 111 include various programs or commands to perform user computations that are also executed on CPU 102. CPU 102 can seamlessly send selected commands for processing on the APD 104. In one example, KMD 110 implements an application program interface (API) through which CPU 102, or applications executing on CPU 102 or other logic, can invoke APD 104 functionality. For example, KMD 110 can enqueue commands from CPU 102 to command buffers 125 from which APD 104 will subsequently retrieve the commands. Additionally, KMD 110 can, together with SWS 112, perform scheduling of processes to be executed on APD 104. SWS 112, for example, can include logic to maintain a prioritized list of processes to be executed on the APD.

In other embodiments of the present invention, applications executing on CPU 102 can entirely bypass KMD 110 when enqueuing commands.

In some embodiments, SWS 112 maintains an active list 152 in memory 106 of processes to be executed on APD 104. SWS 112 also selects a subset of the processes in active list 152 to be managed by HWS 128 in the hardware. Information relevant for running each process on APD 104 is communicated from CPU 102 to APD 104 through process control blocks (PCB) 154.

Processing logic for applications, OS, and system software can include commands specified in a programming language such as C and/or in a hardware description language such as Verilog, RTL, or netlists, to enable ultimately configuring a manufacturing process through the generation of maskworks/photomasks to generate a hardware device embodying aspects of the invention described herein.

A person of skill in the art will understand, upon reading this description, that computing system 100 can include more or fewer components than shown in FIG. 1A. For example, computing system 100 can include one or more input interfaces, non-volatile storage, one or more output interfaces, network interfaces, and one or more displays or display interfaces.

FIG. 1B is an embodiment showing a more detailed illustration of APD 104 shown in FIG. 1A. In FIG. 1B, CP 124 can include CP pipelines 124a, 124b, and 124c. CP 124 can be configured to process the command lists that are provided as inputs from command buffers 125, shown in FIG. 1A. In the exemplary operation of FIG. 1B, CP input 0 (124a) is responsible for driving commands into a graphics pipeline 162. CP inputs 1 and 2 (124b and 124c) forward commands to a compute pipeline 160. Also provided is a controller mechanism 166 for controlling operation of HWS 128.

In FIG. 1B, graphics pipeline 162 can include a set of blocks, referred to herein as ordered pipeline 164. As an example, ordered pipeline 164 includes a vertex group translator (VGT) 164a, a primitive assembler (PA) 164b, a scan converter (SC) 164c, and a shader-export, render-back unit (SX/RB) 176. Each block within ordered pipeline 164 may represent a different stage of graphics processing within graphics pipeline 162. Ordered pipeline 164 can be a fixed function hardware pipeline. Other implementations can be used that would also be within the spirit and scope of the present invention.

Although only a small amount of data may be provided as an input to graphics pipeline 162, this data will be amplified by the time it is provided as an output from graphics pipeline 162. Graphics pipeline 162 also includes DC 166 for counting through ranges within work-item groups received from CP pipeline 124a. Compute work submitted through DC 166 is semi-synchronous with graphics pipeline 162.

Compute pipeline 160 includes shader DCs 168 and 170. Each of the DCs 168 and 170 is configured to count through compute ranges within work groups received from CP pipelines 124b and 124c.

The DCs 166, 168, and 170, illustrated in FIG. 1B, receive the input ranges, break the ranges down into workgroups, and then forward the workgroups to shader core 122.

Since graphics pipeline 162 is generally a fixed function pipeline, it is difficult to save and restore its state, and as a result, the graphics pipeline 162 is difficult to context switch. Therefore, in most cases context switching, as discussed herein, does not pertain to context switching among graphics processes. An exception is for graphics work in shader core 122, which can be context switched.

After the processing of work within graphics pipeline 162 has been completed, the completed work is processed through a render back unit 176, which does depth and color calculations, and then writes its final results to memory 130.

Shader core 122 can be shared by graphics pipeline 162 and compute pipeline 160. Shader core 122 can be a general processor configured to run wavefronts. In one example, all work within compute pipeline 160 is processed within shader core 122. Shader core 122 runs programmable software code and includes various forms of data, such as state data.

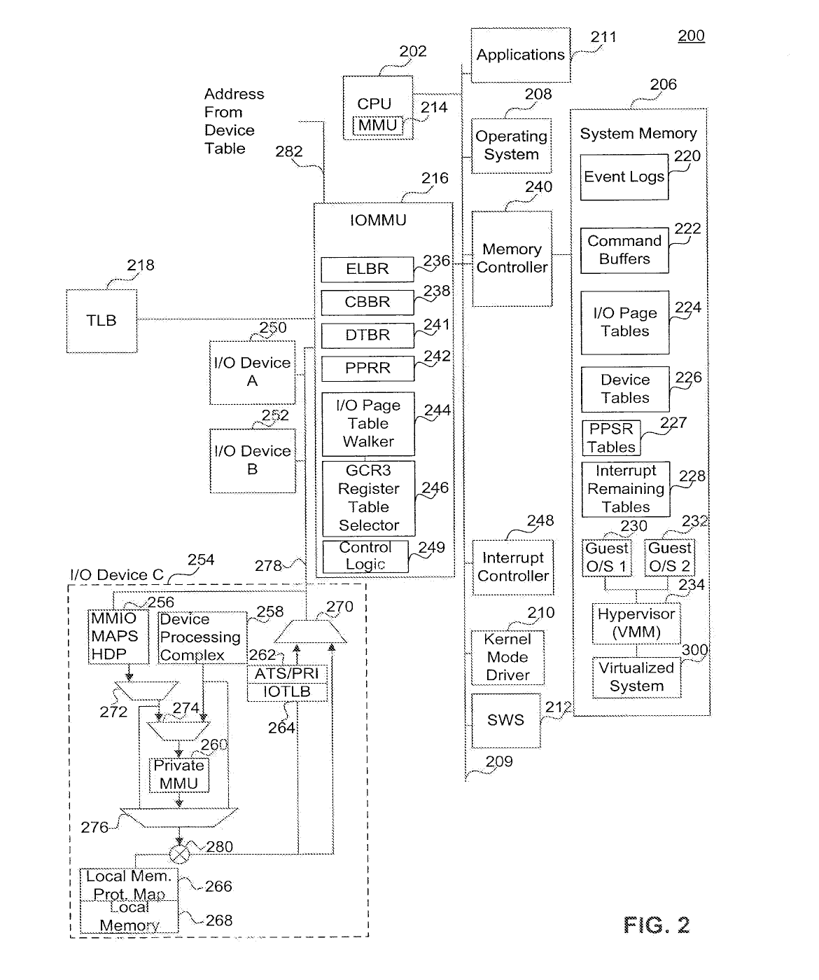

FIG. 2 is an illustrative block diagram of a computing system 200, which is an alternative embodiment of the computing system 100 of FIG. 1A. The computing system 200 includes IOMMU architecture and memory management for a CPU and I/O devices, along with a system memory mapping structure in accordance with embodiments of the present invention. However, details of many of the components of computing system 100, discussed above, also apply to similar components within computing system 200. Therefore, details of these similar components will not be repeated in the discussion of computing system 200.

A memory mapping structure can be configured to operate between memory 206, memory controller 240, IOMMU 216, and I/O devices A, B, and C, represented by numerals 250, 252, and 254, respectively, connected via a bus 278. IOMMU 216 can be a hardware device that operates to translate direct memory access (DMA) virtual addresses into system physical addresses. IOMMU 216 can construct one or more unique address spaces and use the unique address space(s) to control how a device's DMA operation accesses memory. FIG. 2 only shows one IOMMU for the sake of example, and embodiments of the present invention may comprise more than one IOMMU.

Generally, an IOMMU can be connected to its own respective bus and I/O device(s). In FIG. 2, a bus 209 can be any type of bus used in computer systems, including a PCI bus, an AGP bus, a PCI-E bus (which is more accurately described as a point to point protocol), or any other type of bus whether presently available or developed in the future. Bus 209 may further interconnect interrupt controller 248, kernel mode driver 210, SWS 212, applications 211, and OS 208 with other components in system 200.

The I/O Device C may include memory management I/O (MMIO) maps and host data path (HDP) 256, device processing complex 258, private memory management unit (MMU) 260, input output translation lookaside buffer (IOTLB) 264, address translation service (ATS)/page request interface (PRI) request block 262, local memory 268, local memory protection map 266, and multiplexers 270, 272, 274, 276, and 280.

Embodiments of IOMMU 216 may be set up to include device table base register (DTBR) 241, command buffer base register (CBBR) 238, event log base register (ELBR) 236, control logic 249, and peripheral page request register (PPRR) 242. Further, IOMMU 216 can include guest control register table selector 246 to invoke I/O page table walker 244 to traverse the page tables, e.g., for address translations. Also, the IOMMU 216 can be associated with one or more translation look-aside buffers (TLBs) 218 for caching address translations that are used for fulfilling subsequent translations without needing to perform a page table walk. Addresses from a device table can be communicated to IOMMU via bus 282.

Embodiments of the present invention provide for the IOMMU 216 to use I/O page tables 224 to provide permission checking and address translation on memory accessed by I/O devices. Also, embodiments of the present invention, as an example, can use I/O page tables designed in the AMD64 Long format. The device tables 226 allow I/O devices to be assigned to specific domains. The I/O page tables also may be configured to include pointers to the I/O devices' page tables.

Memory 206 further comprises interrupt remapping table (IRT) 228, command buffers 222, event logs 220, and a virtualized system 300 (discussed in greater detail below). Memory 206 also includes a host translation module such as hypervisor 234, along with one or more concurrently running guest OSs such as, but not limited to, guest OS 1, represented by element number 230, and guest OS 2, represented by element number 232.

Further, IOMMU 216 and the memory 206 can be set up such that DTBR 241 points to the starting index of device tables 226. Further, CBBR 238 points to the starting index of command buffers 222. The ELBR 236 points to the starting index of event logs 220. PPRR 242 points to the starting index of PPSR tables 227.

IOMMU 216 can use memory-based queues for exchanging command and status information between the IOMMU 216 and the system processor(s), such as CPU 202. CPU 202 can include MMU 214.

In accordance with one illustrative embodiment, IOMMU 216 may intercept requests arriving from downstream devices (which may be communicated using, for example, HyperTransport™ link or a PCI based bus), perform permission checks and address translation for the requests, and send translated versions upstream to memory 206 space. Other requests may be passed through unaltered.

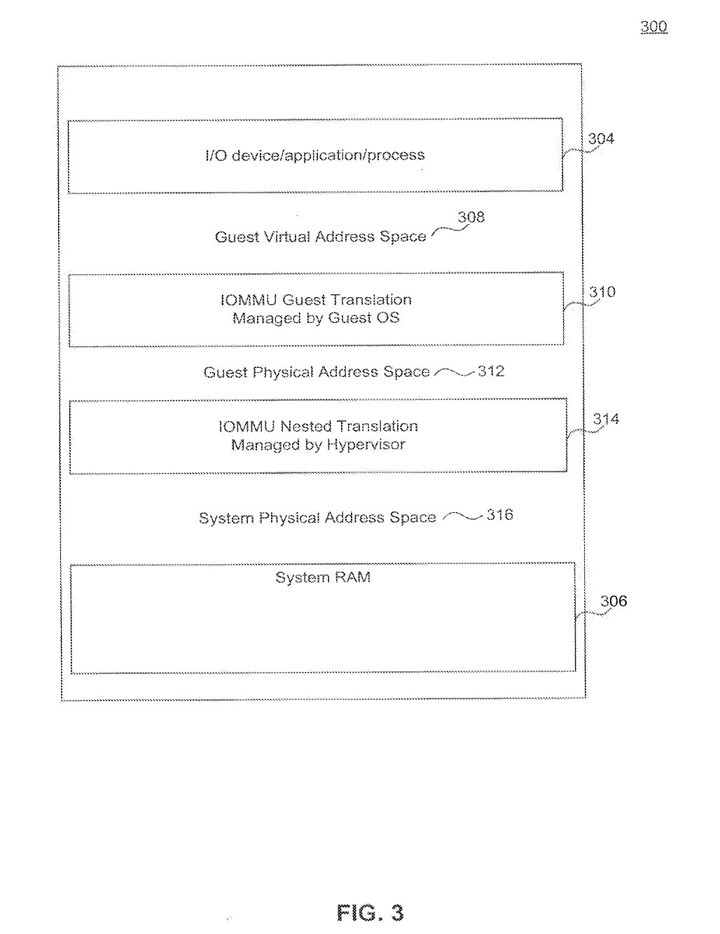

FIG. 3 is a more detailed block diagram illustration of virtualized system 300, shown in FIG. 2, in accordance with embodiments of the present invention. System 300 includes an I/O device/application/process (I/O device 304) and random access memory (RAM) 306.

By way of example, I/O device 304 can include a graphics processing device. The I/O device 304 interacts with the memory 306 in the virtualized system 300 via two-layer address translation provided by an IOMMU.

A guest virtual address (GVA) is provided by the I/O device 304 in a virtualized system 300 for address translation. Thus, the GVA is associated with a guest virtual address space 308. The IOMMU provides a first layer of translation, IOMMU guest translation 310, to convert the GVA to a guest physical address (GPA) associated with guest physical address space 312. The IOMMU guest translation 310 may be managed by a guest OS operating in the virtualized system 300.

The IOMMU also provides a second layer of translation, IOMMU nested translation 314, to convert the GPA to a system physical address (SPA) associated with system physical address space 316. The IOMMU nested translation 314 can be managed by a hypervisor operating in the virtualized system 300. The SPA can be used to access information in the memory 306.

Accordingly, the IOMMU provides two-layer addressing to achieve GVA-to-GPA and GPA-to-SPA translation. The IOMMU provides a hardware solution with improved performance for both layers of address translation, including translations involving peripherals and virtualized guest OSes.

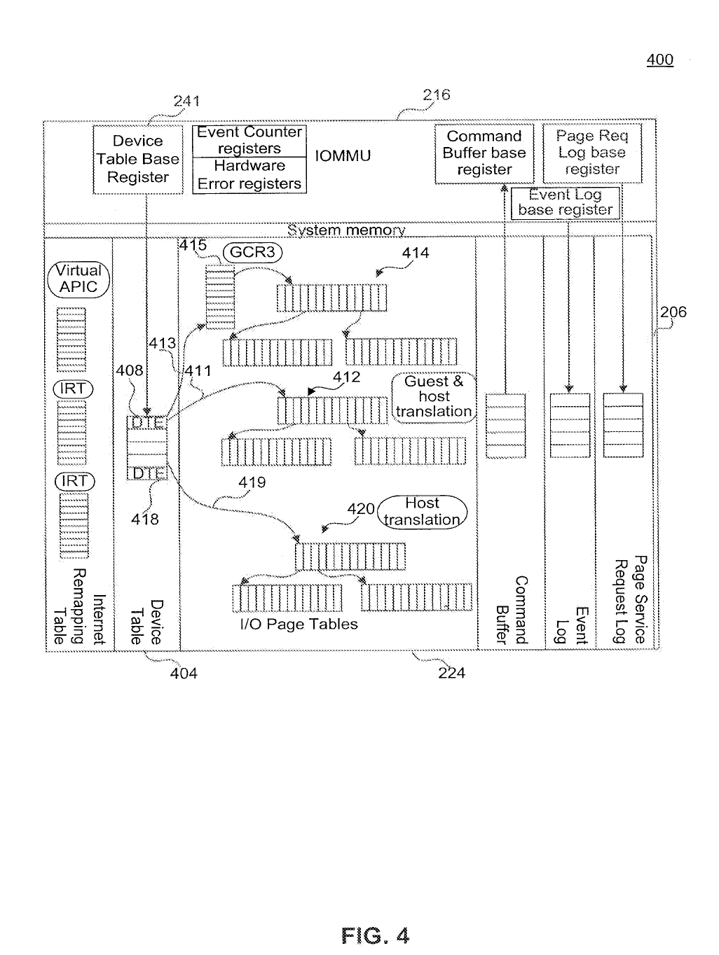

FIG. 4 is an illustrative block diagram 400 of data structures associated with IOMMU 216 and memory 206, in accordance with embodiments of the present invention. As noted above, IOMMU 216 includes various registers, including device table base register 241. Device table base register 241 includes a pointer to the root of device table 404, located within device tables 226 of FIG. 2. Device table 404 includes device table entries (DTEs) 408. Each DTE 408 includes pointers to the root of the data structures for I/O page tables 224 in memory 206.

DTE 408 may include a system pointer 411 pointing to a root of a system address translation table structure 412, and a guest pointer 413 pointing to a root of guest control register table 415/guest address translation table structure 414. Accordingly, the IOMMU 216 may access system/guest address translation table structures 412 and 414 to perform two-layer address translation. For performing GVA-to-GPA translations, the IOMMU 216 may access the I/O page tables 224 using guest pointer 413. For performing GPA-to-SPA translations, the IOMMU 216 accesses the I/O page tables 224 using system pointer 411.

Accordingly, the IOMMU 216 may perform two-layers of address translations concurrently and/or independently. IOMMU 216 may also perform single-layer translation using DTE 418 including a system pointer 419 pointing to a root of a system address translation table structure 420. An entry from the guest address translation table structure 414 may be in the format of a GPA. Each GPA entry may be translated using cascaded/nested walks through the system address translation table structure 412.

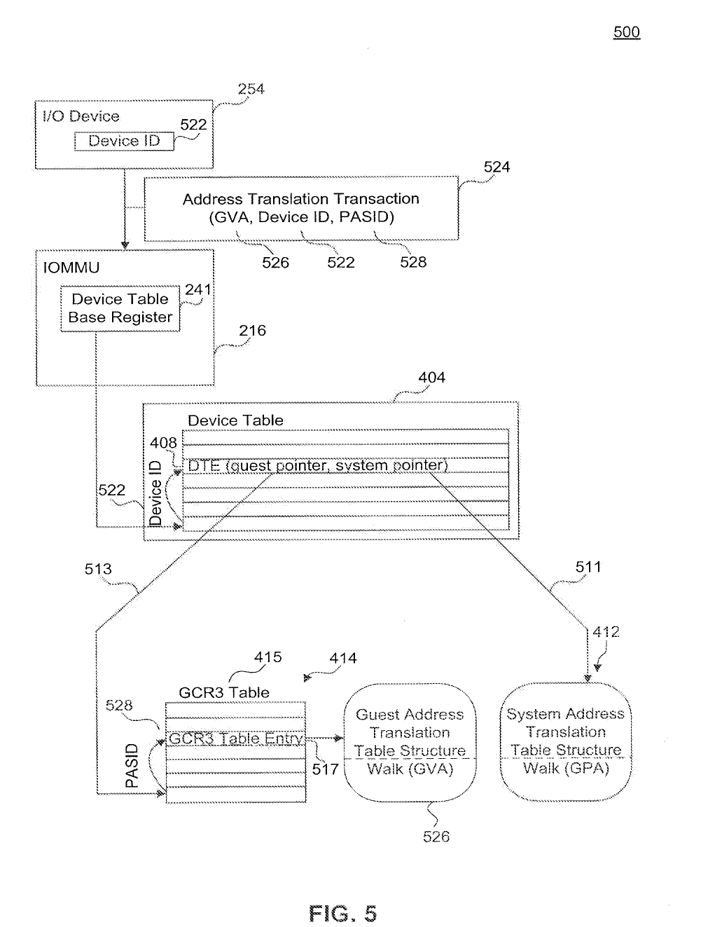

FIG. 5 is an illustrative block diagram 500 of data structures associated with two-layer address translation in accordance with the illustrative embodiment of FIG. 2. I/O device C 254 (see FIG. 2) is associated with a device identifier 522. Device identifier 522 may be used to identify an I/O device. For example, device identifier 522 may be a bus, device, function (BDF) designation used in PCI-E interfaces. The I/O device C 254 issues an address translation transaction 524 (e.g., a request from the I/O device C 254 using address translation service (ATS) according to the PCI-SIG specification). The address translation transaction 524 may include a GVA 526 that the I/O device C 254 needs to have translated. The address translation transaction 524 may also include the device identifier 522 and a process address space identifier 528. The process address space identifier 528 may be used to identify an application address space within a guest virtual machine (VM), and may be used on an I/O device C 254 to isolate concurrent contexts residing in shared local memory. Together, device identifier 522 and process address space identifier 528 may uniquely identify an application address space.

The address translation transaction 524 is received by the IOMMU 216. IOMMU 216 accesses device table 404 based on the device table base register 241 containing a root pointer that points to the root of device table 404.

The device table 404 is indexed using device identifier 522 from the address translation transaction 524 to access DTE 408. DTE 408 contains guest pointer 513 and system pointer 511. System pointer 511 is used to walk the system address translation table structure 412. Guest pointer 513 is used to access the root of guest control register table 415. The guest control register table 415 is indexed using process address space identifier 528 from the address translation transaction 524 to access guest control register table entry 517 that points to the guest address translation table structure 414 corresponding to the address translation transaction 524. The guest address translation table structure 414 is walked using GVA 526 from the address translation transaction 524.

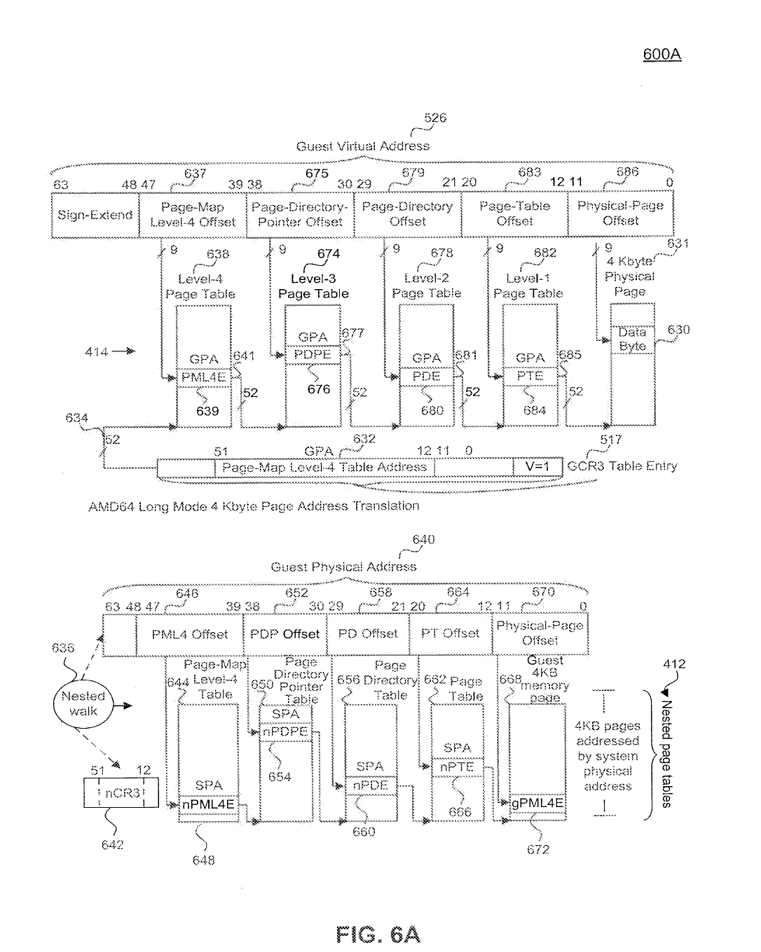

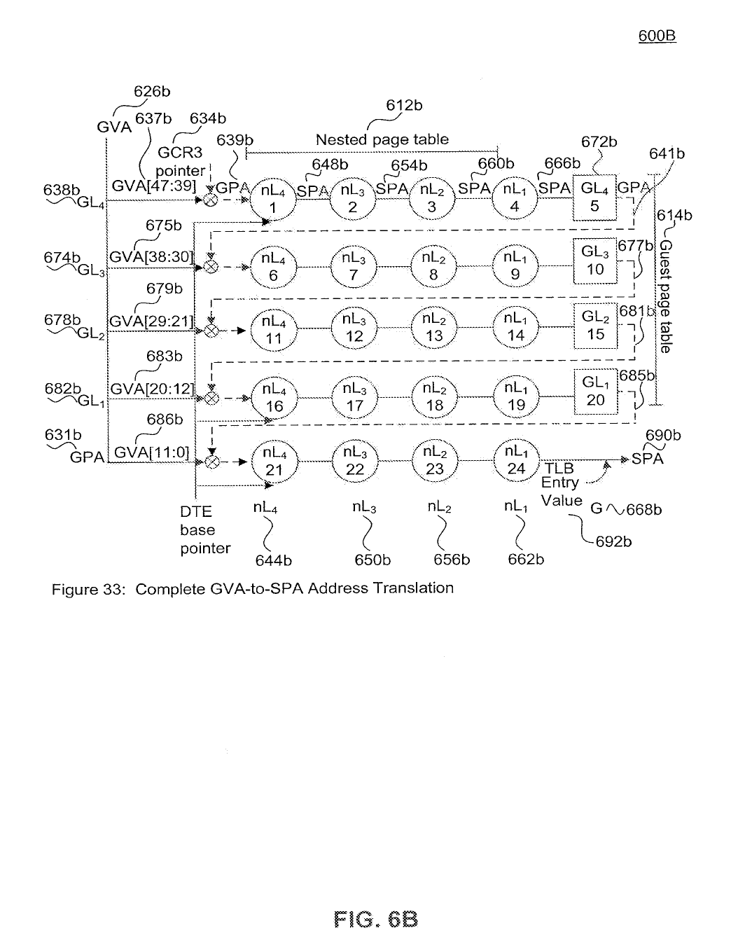

FIG. 6A is an illustrative block diagram of a two-layer address translation system 600A in accordance with the illustrative embodiment of FIG. 2. System 600A includes guest address translation table structure 414 and system address translation table structure 412, illustrated in FIG. 4. A four-level page table structure is illustrated and used to access the 4 Kbyte physical page 631. Embodiments may provide page table structures using greater or fewer levels (e.g., a three-level page table structure referencing a 2 Mbyte physical page; a two-level page table structure referencing a 1 Gbyte physical page; etc.). GVA 526 may be provided by an I/O Device issuing an address translation transaction (e.g., a request for ATS), and GVA 526 is to be translated ultimately into a SPA associated with accessing data byte 630. Guest control register table entry 517 may be obtained by walking the device table and guest control register table (as explained above with reference to FIG. 5) using the device identifier and process address space identifier also provided by the address translation transaction.

The guest control register table entry 517 includes a page-map level-4 (PML4) table address 632. Although the PML4 table address 632 corresponds to root page table pointer 634, the PML4 table address 632 is in the format of a GPA. The system 600A performs a nested walk 636 to convert the PML4 table address 632 from GPA format to SPA format. The SPA corresponds to the system physical address of the root of the level-4 page table 638. Thus, the heavy black lines associated with, e.g., root page table pointer 634, may represent a SPA obtained using a nested walk 636. Level-4 page table 638 is identified using root page table pointer 634, and entries of the level-4 page table 638 are indexed using page-map level-4 (PML4) offset 637. PML4 offset 637 is associated with bits 39-47 of the GVA 526 that is to be translated. Accordingly, PML4 entry (PML4E) 639 is located using root page table pointer 634, level-4 page table 638, and PML4 offset 637. Because the PML4E 639 is a GPA, system 600A converts it to an SPA using a nested walk 636.

Nested walk 636 may be implemented using system address translation table structure 412 to perform GPA-to-SPA conversions for each of the GPAs from guest address translation table structure 414. For example, GPA 640 may be loaded with PML4E 639 for conversion to obtain a corresponding SPA for root page table pointer 641 in guest address translation table structure 414. GPA 640 includes offsets used to index the various tables of the system address translation table structure 412.

Nested walk 636 uses nested control register 642 associated with PML4E 639 to locate the root of page-map level-4 (PML4) table 644. PML4 offset 646 (bits 39-47 of GPA 640) is used to index into PML4 table 644 and obtain the entry nPML4E 648. nPML4E 648 points to the root of page directory pointer (PDP) table 650, and PDP offset 652 (bits 30-38 of GPA 640) is used to index into PDP table 650 and obtain the entry nPDPE 654. nPDPE 654 points to the root of page directory (PD) table 656, and PD offset 658 (bits 21-29 of GPA 640) is used to index into PD table 656 and obtain the entry nPDE 660. nPDE 660 points to the root of page table 662, and PT offset 664 (bits 12-20 of GPA 640) is used to index into page table 662 and obtain the entry nPTE 666. nPTE 666 points to the root of guest 4 KB memory page 668, and physical page offset 670 (bits 0-11 of GPA 640) is used to index into guest 4 KB memory page 668 and obtain the entry gPML4E 672. gPML4E 672 is a SPA value corresponding to the GPA PML4E 639 and used for root page table pointer 641 to locate level-3 page table 674 in guest address translation table structure 414.

Level-3 page table 674 is indexed using page-directory-pointer (PDP) offset 675 to obtain PDPE 676 (GPA format). A nested walk 636 is used to convert the GPA PDPE 676 into a SPA value corresponding to root page table pointer 677. Root page table pointer 677 is used to locate level-2 page table 678, which is indexed using page-directory offset 679 (bits 21-29 of GVA 526) to obtain PDE 680 (GPA format). A nested walk 636 is used to convert the GPA PDE 680 into a SPA value corresponding to root page table pointer 681. Root page table pointer 681 is used to locate level-1 page table 682, which is indexed using page-table offset 683 (bits 12-20 of GVA 526) to obtain PTE 684 (GPA format). A nested walk 636 is used to convert the GPA PTE 684 into a SPA value corresponding to root page table pointer 685. Root page table pointer 685 is used to locate 4 Kbyte physical page 631, which is indexed using physical page offset 686 (bits 0-11 of GVA 526) to obtain data byte 630.

Thus, system 600A use nested cascades of page table walks to perform two-layer GVA-to-GPA and GPA-to-SPA address translations. Although two-layers of nested address translation are shown, additional layers may be implemented using similar nested/recursive calls. The translations associated with system address translation table structure 412 and guest address translation table structure 414 may be implemented in hardware. One set of hardware may be used for both sets of translations, although separate hardware may be provided for each set of the guest/system translations.

FIG. 6B is an illustrative block diagram of a GVA-to-SPA address translation system 600B in accordance with embodiments of the present invention. FIG. 6B represents a sequence of nested translations, using multiple invocations of the system/guest address translation table structures 412/414 of FIGS. 5 and 6A, to achieve a GVA-to-SPA address translation. Elements in system 600B that correspond to system 600A are designated using the same or similar reference numerals, and include the letter “b” (e.g., 414 and 614b; 526 and 626b; 637 and 637b; and so on). System 600B represents a nested page table walk using guest page table 614b and nested page table 612b. Guest page table 614b includes GL₄ 638b, GL₃ 674b, GL₂ 678b, GL₁ 682b, and GPA 631b (corresponding to the page table levels in guest address translation table structure 414 of system 600A).

Guest page table 614b also includes nL₄ 644b, nL₃ 650b, nL₂ 656b, nL₁ 662b, and G 668b (corresponding to the page table levels in system address translation table structure 412 of system 600A). Translation from GVA-to-SPA starts at the top left of system 600B, using GVA 626b provided by an address translation transaction from an I/O device. Guest control register pointer 634b is used to locate the root of GL₄ 638b, and GVA[47:39] 637b is used to index into GL₄ 638b and obtain GPA 639b. A first nested lookup (nL₄ 1) is performed to obtain SPA 648b, which points to a second nested lookup (nL₃ 2) to obtain SPA 654b, which points to a third nested lookup (nL₂ 3) to obtain SPA 660b, which points to a fourth nested lookup (nL₁ 4) to obtain SPA 666b, which points to GL₄ 5 672b that is used to obtain root page table pointer 641b that points to the root of GL₃ 674b.

The next set of bits from GVA 626b, corresponding to GVA[38:30] 675b, is used as an offset from root page table pointer 641b to index into GL₃ 674b and obtain a pointer to the next nested cascade (nL₄ 6-nL₁ 9) that ultimately produces root page table pointer 677b. The next set of bits from GVA 626b, corresponding to GVA[29:21] 679b, is used as an offset from root page table pointer 677b to index into GL₂ 678b and obtain a pointer to the next nested cascade (nL₄ 11-nL₁ 14) that ultimately produces root page table pointer 681b. The next set of bits from GVA 626b, corresponding to GVA[20:12] 683b, is used as an offset from root page table pointer 681b to index into GL₁ 682b and obtain a pointer to the next nested cascade (nL₄ 16-nL₁ 19) that ultimately produces root page table pointer 685b.

The last set of bits from GVA 626b, corresponding to GVA[11:0] 686b, is used as an offset from root page table pointer 685b to index into GPA 631b and obtain a pointer to the next nested cascade (nL₄ 21-nL₁ 24) that ultimately produces the desired SPA 690b.

SPA 690b corresponds to GVA 626b, provided by the I/O device transaction/request for a GVA-to-SPA address translation. SPA 690b may be obtained by walking the page tables as illustrated in FIGS. 6A and 6B. Additionally, SPA 690b may be cached as a translation look-aside buffer (TLB) entry value 692b. Accordingly, future requests to translate GVA 526/626b may be fulfilled by accessing the TLB entry value 692b to quickly produce SPA 690b corresponding to GVA 526/626b, thereby avoiding a need to walk the page tables. TLB entry value 692b may be stored in an IOTLB associated with and/or incorporated into the IOMMU, and also may be stored in a TLB remote from the IOMMU.

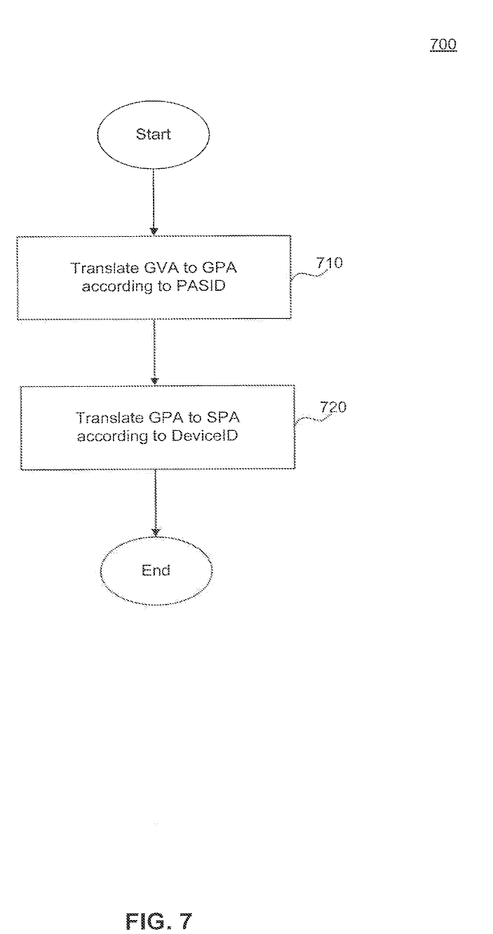

FIG. 7 is an illustrative block diagram of a flowchart 700 illustrating two-layer addressing in accordance with embodiments of the present invention. In step 710, a GVA is translated to a GPA for a transaction. The transaction may include a transaction layer packet (TLP) prefix, which may have a standardized format for the PCIe bus according to, e.g., the PCI-SIG PASID TLP Prefix ECN specification. The IOMMU may identify that the process address space identifier is carried in the TLP prefix, and the process address space identifier may be used to select the guest tables for GVA-to-GPA translation.

In step 720, the GPA is translated to a system physical address (SPA). Translation tables may be selected according to the device identifier carried by the transaction. For example, when a PCIe transaction has no TLP prefix, a system may determine that the packet contains a GPA. Accordingly, the originating device identifier may be used to select the GPA-to-SPA translation tables.

The IOMMU may inspect packets for TLP prefixes and behave accordingly. If the PCIe transaction contains a valid process address space identifier, the packet contains a GVA. The process address space identifier is used to select the GVA-to-GPA translation tables, and the device identifier (e.g., a BDF on a PCI-E bus) is used to select GPA-to-SPA tables. If the IOMMU does not detect a valid process address space identifier, the packet is presumed to contain a GPA and the device identifier is used to select GPA-to-SPA translation tables. Accordingly, the presence or absence of a valid process address space identifier in a transaction may be identified by the IOMMU as whether a one-layer (GPA-SPA) or two-layer (GVA-to-GPA and GPA-to-SPA) address translation is requested.

### CONCLUSION

The Summary of Embodiments of the Invention and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method, comprising:
translating a guest virtual address (GVA) to a corresponding guest physical address (GPA) using a process address space identifier associated with an address translation transaction associated with an I/O device; and
translating the GPA to a corresponding system physical address (SPA) using a system address translation table according to a device identifier associated with the address translation transaction.

2. The method of claim 1, further comprising:
cascading a plurality of GPA-to-SPA translations for each GVA-to-GPA translation.

3. The method of claim 1, wherein, for a guest page table of a given level, the GVA is operable to index that guest page table to access a guest page table entry associated with a guest root page table pointer that points to a root of a guest page table at a next level.

4. The method of claim 3, further comprising:
translating the guest page table entry to the guest root page table pointer using a GPA-to-SPA translation.

5. The method of claim 4, wherein for a nested page table of a given level, the GPA is operable to index that nested page table to access a nested page table entry associated with a nested root page table pointer that points to a root of a nested page table at a next level.

6. The method of claim 5, wherein the nested page table entry is a SPA.

7. The method of claim 1, wherein:
the translating the GVA further comprises accessing a guest pointer of a device table entry; and
the translating the GPA further comprises accessing a system pointer of the device table entry.

8. The method of claim 1, wherein:
the translating the GVA is manageable by a guest operating system (OS); and
the translating the GPA is manageable by a hypervisor.

9. A system, comprising:
an input/output memory management unit (IOMMU) operable to translate a guest virtual address (GVA) to a corresponding guest physical address (GPA) using a process address space identifier associated with an address translation transaction associated with an I/O device; and
the IOMMU is further operable to translate the GPA to a corresponding system physical address (SPA) using a system address translation table according to a device identifier associated with the address translation transaction.

10. The system of claim 9, further comprising:
a module operable to cascade a plurality of GPA-to-SPA translations for each GVA-to-GPA translation.

11. The system of claim 9, wherein, for a guest page table of a given level, the GVA is operable to index that guest page table to access a guest page table entry associated with a guest root page table pointer that points to a root of a guest page table at a next level.

12. The system of claim 11, further comprising:
a module operable to translate the guest page table entry to the guest root page table pointer using a GPA-to-SPA translation.

13. The system of claim 12, wherein for a nested page table of a given level, the GPA is operable to index that nested page table to access a nested page table entry associated with a nested root page table pointer that points to a root of a nested page table at a next level.

14. The system of claim 13, wherein the nested page table entry is a SPA.

15. The system of claim 9, wherein:
the IOMMU is further operable to translate the GVA by accessing a guest pointer of a device table entry; and
the IOMMU is further operable to translate the GPA by accessing a system pointer of the device table entry.

16. The system of claim 9, wherein:
a guest operating system (OS) manages the GVA translating; and
a hypervisor manages the GPA translating.

17. A computer readable medium storing instructions, wherein said instructions when executed cause a method comprising:
translating a guest virtual address (GVA) to a corresponding guest physical address (GPA) based on a process address space identifier associated with an address translation transaction associated with an I/O device; and
translating the GPA to a corresponding system physical address (SPA) based on a device identifier associated with the address translation transaction.

18. The computer readable medium of claim 17, wherein:
a guest operating system (OS) manages the GVA translating; and
a hypervisor manages the GPA translating.
